(19) United States
(12) Patent Application Publication
(10) Pub. No.: US 2017/0124538 A1
(43) Pub. Date: May 4, 2017

(54) SYSTEM AND METHOD FOR FACILITATING MICRO-DONATIONS ON PAYMENT CARD AND OTHER CASHLESS TRANSACTIONS

(71) Applicant: Shea Rouda, Laguna Beach, CA (US)

(72) Inventor: Shea Rouda, Laguna Beach, CA (US)

(21) Appl. No.: 15/286,142

(22) Filed: Oct. 5, 2016

Related U.S. Application Data
(60) Provisional application No. 62/249,729, filed on Nov. 2, 2015.

(51) Int. Cl. G06Q 20/10; G06Q 20/32

(52) U.S. Cl. CPC G06Q 20/10; G06Q 20/325

(57) ABSTRACT

A system for facilitating micro-donations comprises a financial institution, a linked payment card or bank account, and a server in communication the financial institution and configured to host an application. The application monitors transactions performed by the linked payment card or bank account and provisionally rounds them up to the next dollar. When a donation target amount or time period is reached, the user is sent a message noting the total amount and asking for a selection to donate the amount to a previously selected philanthropic organization, or to keep the funds.

### CROSS-REFERENCE TO RELATED APPLICATION

This application claims the benefit of U.S. Provisional Application No. 62/249,729, filed Nov. 2, 2015 the disclosure of which is incorporated herein by reference.

### TECHNICAL FIELD

Exemplary embodiments of the present invention relate generally to a system and method for facilitating micro-donations on payment card transactions, including a system for communicating content to subscribers.

### BACKGROUND AND SUMMARY OF THE INVENTION

Companies, not-for-profit groups, and other organizations have long encouraged customers, friends, or passersby's to donate their spare change as a form of micro-donation. Stores often place receptacles at the point of sale for donating spare change to a charitable organization and the sound of the bell ringers and the sight of the red kettle of the Salvation Army® have become synonymous with micro-donations during the winter holiday season.

Recently, cash transactions have declined as the number of consumer using payment cards, such as debit cards, credit cards, stored value cards, checks, negotiable instruments, and other cashless payment devices has increased. Therefore, individuals often do not have spare change on their person for making such a donation, though they may wish to continue their micro-donation practices. As such, it would be desirable to provide a system and method for facilitating micro-donations using credit cards, debit cards, and other cashless payment devices.

In addition, mail, telephones, cell phones, fax, email, text messaging, and other new forms of telecommunications have facilitated the communication and collaboration of users across a global network. These new forms of telecommunication have brought together individuals across great distances and have provided society with reliable, efficient, and convenient forms of telecommunications, fostering collaboration and innovation. They have also, however, de-personalized communication in some aspects. For example, without limitation, today a person may buy a good online without ever setting foot in a store or interacting with a sales representative or cashier. The same person may, again for example, transact most of their banking services thorough the internet without ever speaking with a teller or the recipient/transmitter of funds.

These systems and methods can be convenient and efficient, however, they can also be impersonal. This impersonality may cause the customer to lose interest or a sense of connection with the company, thereby decreasing the likelihood that the customer will become a return customer. Again, for example without limitation, a charitable organization may receive donations from individuals online. However, if the donors do not have a face and/or an action/event to associate with their donation, they may lose interest and eventually stop donating. Therefore, what is needed is a system for periodically communicating content to subscribers or donors. (“Subscribers” and/or “Donors” is used interchangeably herein to refer to one or both of subscribers and/or donors).

The present invention provides a system and method for facilitating micro-donations using credit cards, debit cards, and other cashless payment devices. An application (hereinafter also “app”) for a portable electronic device allows a user to link their bank account, credit cards, and debit cards to the app. The user may then select a philanthropic organization the user would like to support. The user may select a target amount or periodic goal for donation. When the user performs a transaction with their linked credit, debit card, negotiable instrument or other payment device, the application records the transaction, provisionally rounds up the transaction to the nearest dollar, and displays a visualization of user's progress.

Once the target amount or time period goal has been reached, the app sends the user a message noting the amount and giving the user the option to donate or keep the provisionally allocated amount. If the user chooses to donate the amount, the total is recorded and the funds are sent to the philanthropic organization selected by the user. The app may track the user's total donation amounts for records keeping purposes and so that the user may, among other applications, use the record as proof of donation for applicable tax deductions.

In addition, the present invention provides a system for periodically communicating content to subscribers. The system may comprise an electronic device having an application installed thereon or being configured to access a web portal that permits an organization to create messages by uploading content and drafting text to be sent to their subscribers or donors. The application or the web-based portal may also permit the organization to specify a pre-determined amount of allotted time to send the message and said messages may be stored on a server until the per-determined amount of allotted time is reached. Once the predetermined amount of allotted time has been reached, the message may be sent to the subscribers' electronic devices. For example, without limitation, the charitable organization may periodically send messages to their subscribers or donors showing examples of individuals and/or actions and events that their donation have helped to fund. This may keep the subscribers or donors interested and engaged with the charity, thereby increasing donations, involvement, and awareness.

### BRIEF DESCRIPTION OF THE DRAWINGS

In addition to the features mentioned above, other aspects of the present invention will be readily apparent from the following descriptions of the drawings and exemplary embodiments, wherein like reference numerals across the several views refer to identical or equivalent features, and wherein:

FIG. 1 is an exemplary method in accordance with the present invention;

FIG. 2 illustrates an exemplary app in accord with the present invention;

FIG. 3 is another view of the app of FIG. 1;

FIG. 4 is another view of the app of FIG. 1;

FIG. 5 is another view of the app of FIG. 1;

FIG. 6 is another view of the app of FIG. 1;

FIG. 7 is another view of the app of FIG. 1;

FIG. 8 is another view of the app of FIG. 1;

FIG. 9 is another view of the app of FIG. 1;

FIG. 10A is another view of the app of FIG. 1;

FIG. 10B is another view of the app of FIG. 1;

FIG. 11 is another view of the app of FIG. 1;

FIG. 12 is another view of the app of FIG. 1;

FIG. 13 is another view of the app of FIG. 1;

FIG. 14 is another view of the app of FIG. 1;

FIG. 15A is another view of the app of FIG. 1;

FIG. 15B is another view of the app of FIG. 1;

FIG. 16 is another view of the app of FIG. 1;

FIG. 17 is an exemplary flow chart in accordance with the present invention;

FIG. 18 is another exemplary flow chart in accordance with the present invention;

FIG. 19 shows an exemplary flow chart in accordance with the present invention;

FIG. 20 shows an exemplary system in accordance with the present invention;

FIG. 21 shows an exemplary web portal for use in the present invention;

FIG. 22 shows an exemplary message generator for use in the present invention;

FIG. 23 shows an exemplary message as received by a subscriber in accordance with the present invention; and

FIG. 24 shows an exemplary system in accordance with the present invention.

### DETAILED DESCRIPTION OF EXEMPLARY EMBODIMENT(S)

Various embodiments of the present invention will now be described in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

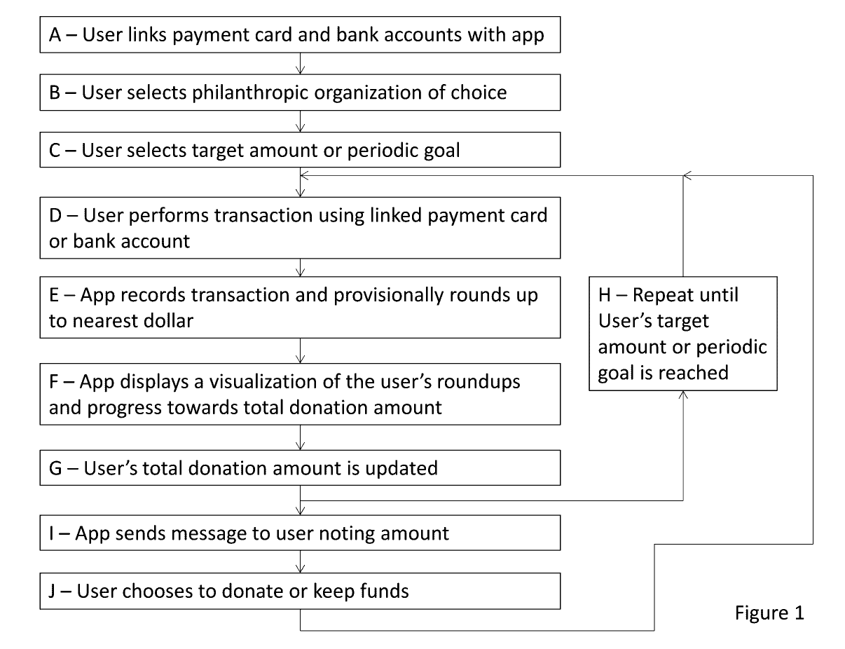

FIG. 1 illustrates an exemplary method in accordance with the present invention. As will be discussed in greater detail, an app 100 may provide a system and method for facilitating micro-donations using credit cards, debit cards, stored value cards, checks, negotiable instruments, the like, and other cashless payment devices. After installing the app 100 on their electronic device, in step A the user may link their bank account, credit cards, debit cards, other cashless payment devices, and the like to the app 100. In step B the user may select a philanthropic organization the user would like to support. Next, in step C the user may select a target amount or periodic goal for donation. When the user performs a transaction, as in step D, with their linked cashless payment device or the like, the application records the transaction, provisionally rounds up the transaction to the nearest dollar in step E.

It is notable that the provisional allocation may be for internal tracking purposes only. Any such provisional allocation may not involve debiting or otherwise transacting with the user's accounts. In step F the app 100 displays a visualization of the user's roundups and progress towards total donation. The visualization may be based on the internal tracking of the funds allocated towards the user's total donation. The total donation amount is then updated in step G. As described in step H, step D through step G may be repeated until the user's target amount or periodic goal is reached.

Once the target amount or time period goal has been reached, in step I the app 100 may send the user a message noting the amount and, as described in step J, the app 100 may give the user the option to donate or keep the provisionally allocated amount. If the user chooses to donate the amount, the total may be recorded and the funds are sent to the philanthropic organization selected by the user. The app may track the user's total donation amounts for records keeping purposes so that the user may, among other applications, use the record as proof of donation for applicable tax deductions. Finally, in exemplary embodiments of the present invention step D through step J may be automatically repeated. In other exemplary embodiments, step C through step J may be repeated, such that the user is required to set a new target amount or periodic goal to continue. Any combination or order of the aforementioned steps is contemplated.

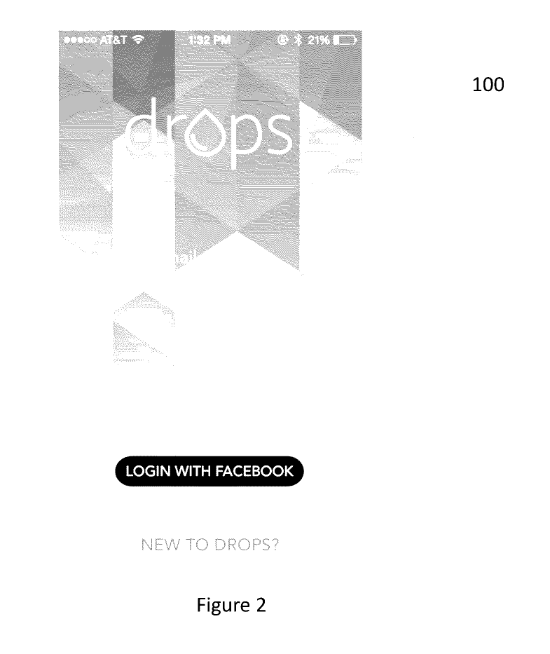

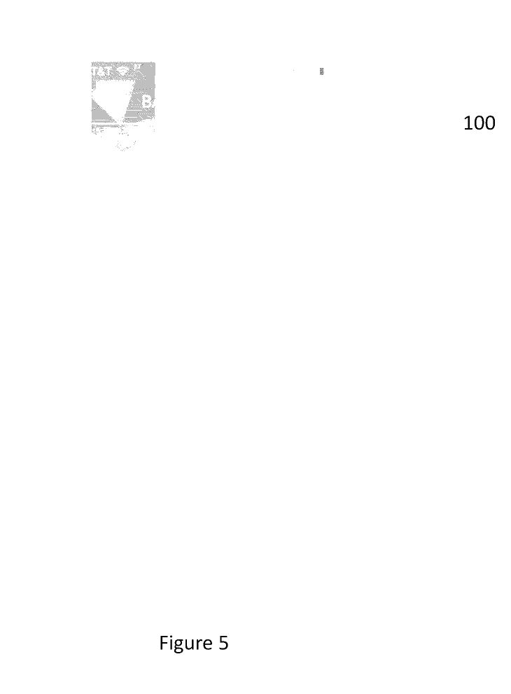

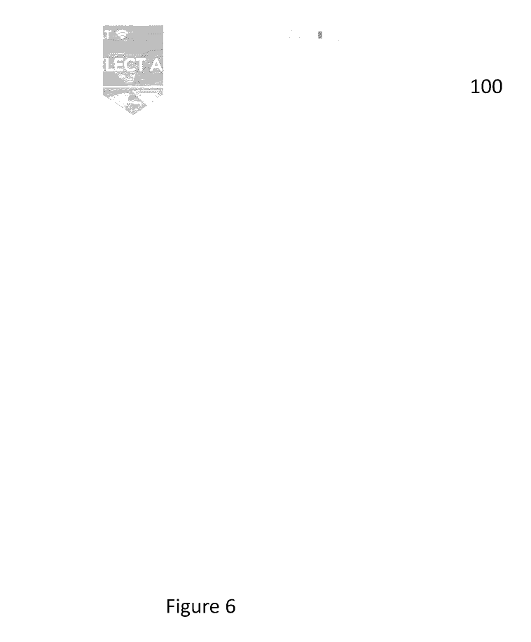

FIG. 2 through FIG. 16 illustrates various views of an app 100 in accordance with the present invention. The illustrated views are merely exemplary and are not intended to be limiting. The illustrated views show examples of how the app 100 may operate. However, any appearance or operation consistent with the functionality of the app 100 and related systems and methods described herein are contemplated. The views may include a graphical user interface viewable by a user when operating the app 100.

In exemplary embodiments of the present invention, the app is installed on the user's portable electronic device. The portable electronic device may include, but is not limited to, an iPhone, smart phone, iPad, tablet, iPod, e-reader, laptop, and the like. In other exemplary embodiment of the present invention, the app may be accessible by any electronic device, such as through a website. In exemplary embodiments of the present invention, the app 100 is installed on a touch screen device capable of responding to the user's touch or other gestures, though installation on any electronic device is contemplated. Navigational tools, such as arrows, menu buttons, prompts, and the like may be present that permit a user to navigate the app 100.

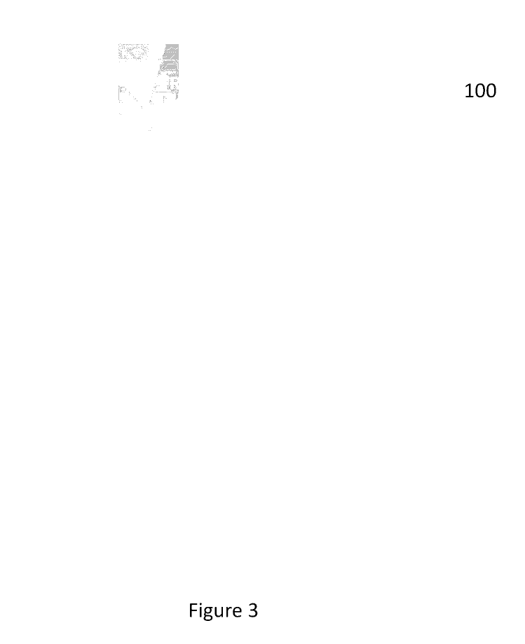

FIG. 2 illustrates an exemplary login screen. An existing user may login using their email address and password. In exemplary embodiments of the present invention, the user may login using another application, such as Facebook or the like. A new user may register using the provided link and complete the registration process as detailed in FIG. 3 through FIG. 6.

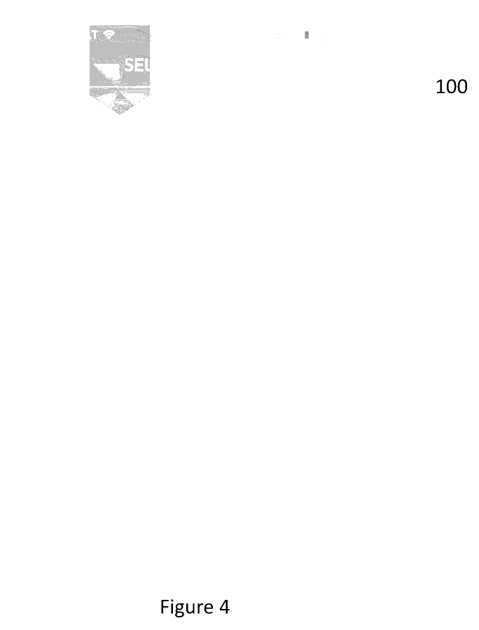

FIG. 3 through FIG. 6 permit the user to enter the requisite information needed to operate the app 100. Specifically, in FIG. 4 through FIG. 6 the user may link their bank account, including their payment cards and account the user designates to withdraw donation funds from.

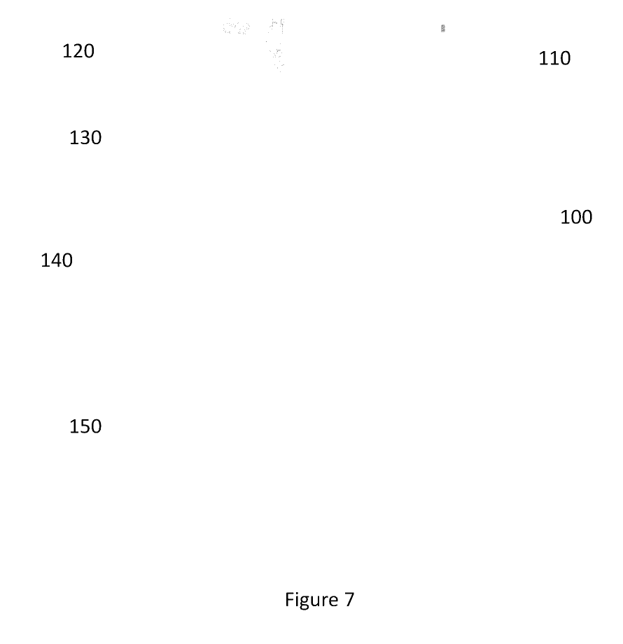

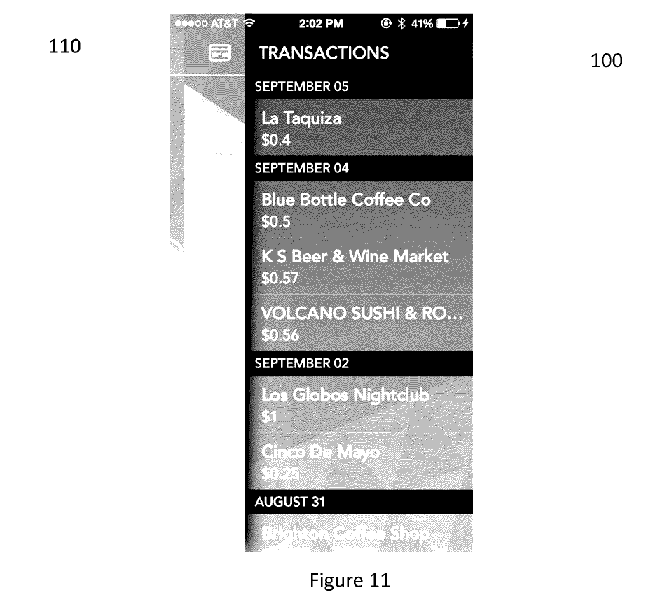

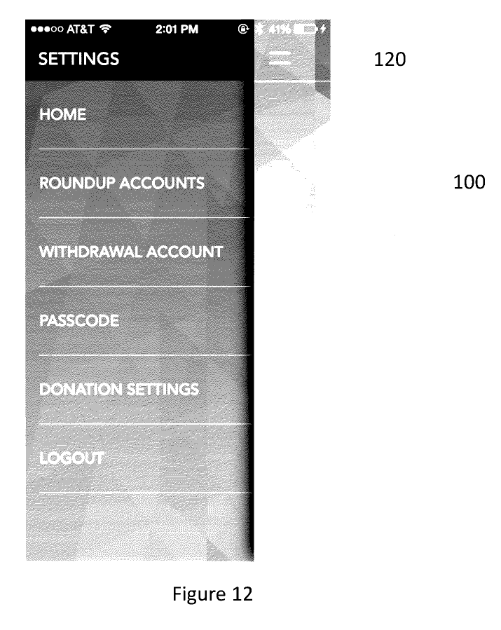

FIG. 7 illustrates an exemplary home screen. This may be the screen that a registered user first sees after logging into the app 100. A link to the user's transactions 110 may be provided. This transactions link 110 is best illustrated in FIG. 11. A menu link 120 may provide the user with a series of further options as best illustrated in FIG. 12. A current total 130 may be displayed detailing the current amount of donation that the app 100 has provisionally allocated to the user's philanthropic organization of choice. The current total 130 may also be displayed as a percentage to total goal 150.

As will be explained in greater detail, the user may be permitted to set a target amount or a periodic goal for donations. If the latter is selected, the percentage to total goal 150 may be a function of the time remaining until the next periodic goal. In other exemplary embodiments of the present invention, a countdown, timer, or counter may be used to show the time remaining until the periodic goal is completed, or the time elapsed since the periodic goal was instated. If the target amount is selected, the percentage to total goal 150 may be a function of the total donation amount provisionally accrued compared to the goal amount. The percentage to total goal 150 may also be expressed as a graphic 140. In exemplary embodiment of the present invention, the graphic 140 is a bucket where the water level rises as a function of the progress to total goal 150.

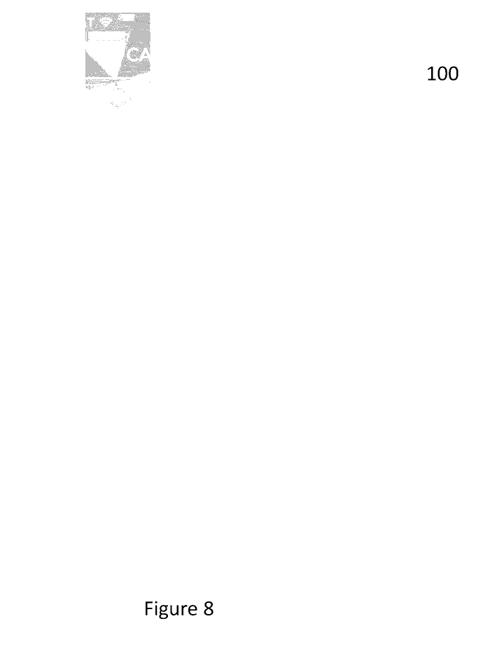

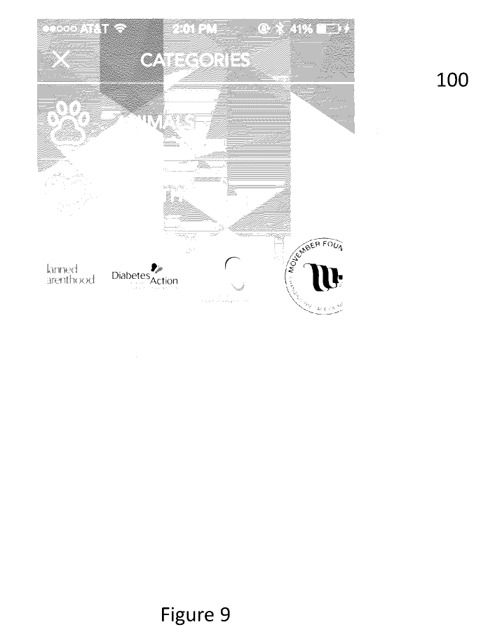

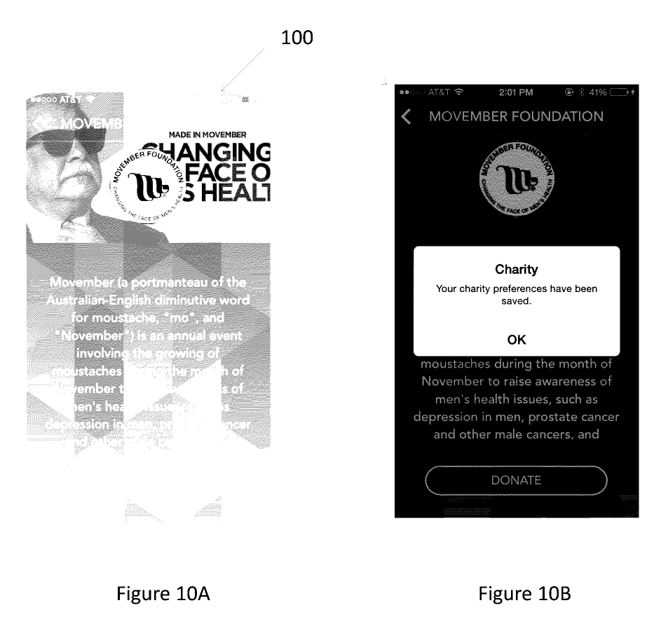

FIG. 8 through FIG. 10B illustrates an exemplary selection screen for philanthropic organizations. Upon registration, the user may be prompted to select a philanthropic organization. Additionally, the user may change the selected philanthropic organization at any time using the menu link 120 option shown in FIG. 7. As best illustrated in FIG. 8, the philanthropic organizations may be organized by category. The categories may include, without limitation, animals, health, community development, research/policy, environment, arts, human services, faith, education, and the like. As best illustrated in FIG. 9, the user may select a category by touch, click, swipe, or the like, and a list of philanthropic organizations may be displayed. After selecting a philanthropic organization, as best shown in FIG. 10A and FIG. 10B, information about the philanthropic organization may be displayed to assist the user in making an informed decision regarding what organization to donate to. In exemplary embodiments of the present invention, this information may be pulled from an internet website, such as Wikipedia, the philanthropic organizations' website, the app's 100 own database, or the like.

FIG. 11 illustrates the transactions that may be displayed when the user selects the transactions link 110 shown in FIG. 7. The user may select the transaction link 100 by touch, click, double click, depression, swipe, pinch, or the like. Upon activation, a series of the user's recent transaction may be displayed. The information may include the date of the transaction and the name of the transacting organization. The provisionally rounded up amount may be also displayed. Other information including the transaction amount, time, location, and other relevant information may also be displayed.

FIG. 12 illustrates a settings screen that may be accessed by use of the menu link 120. This may display a list of various options for the user to access, including but not limited to, the home page, roundup accounts, withdrawal account, pass codes, donation settings, log out, and other relevant options and preference settings.

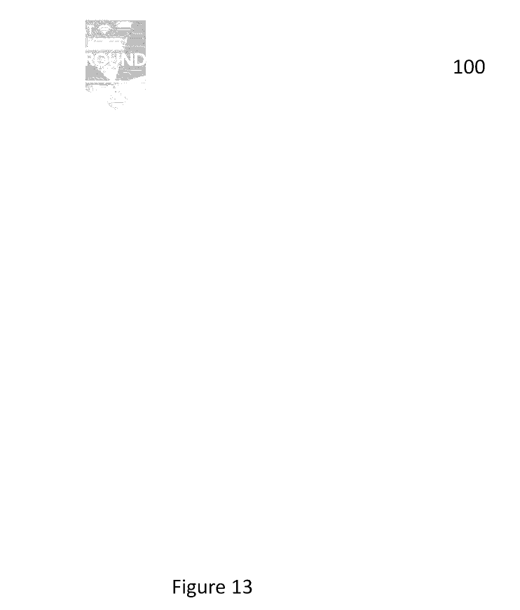

FIG. 13 illustrates a roundup accounts screen that may be accessed through the setting screen shown in FIG. 12. The roundup accounts may list the user's various payment cards and accounts that the user has synced with the app 100. The app 100 may roundup all transactions performed for each of the roundup accounts listed therein. The name of the bank for the linked accounts may be listed. An option to unlink the accounts may also be present. Likewise, an option to like new or additional accounts may also be present.

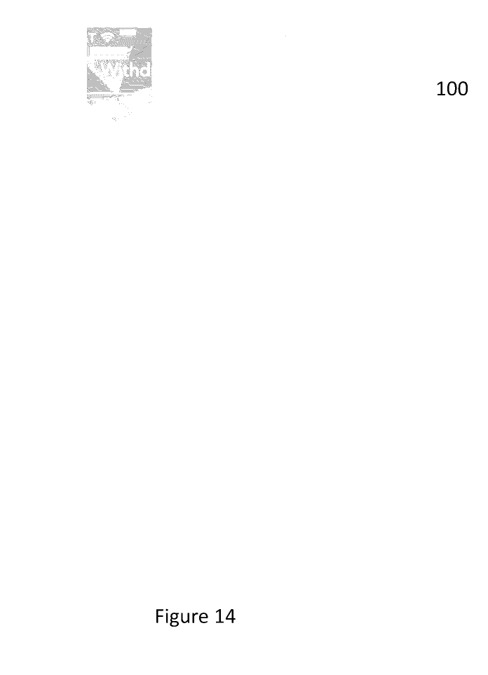

FIG. 14 illustrates a withdrawal account screen that may be accessed through the setting screen shown in FIG. 12. The withdrawal accounts may list the user's various accounts that the user has synced with the app 100 to withdrawal donation funds from. The name of the bank for the linked accounts may be listed. An option to unlink the accounts may also be present. Likewise, an option to like new or additional accounts may also be present.

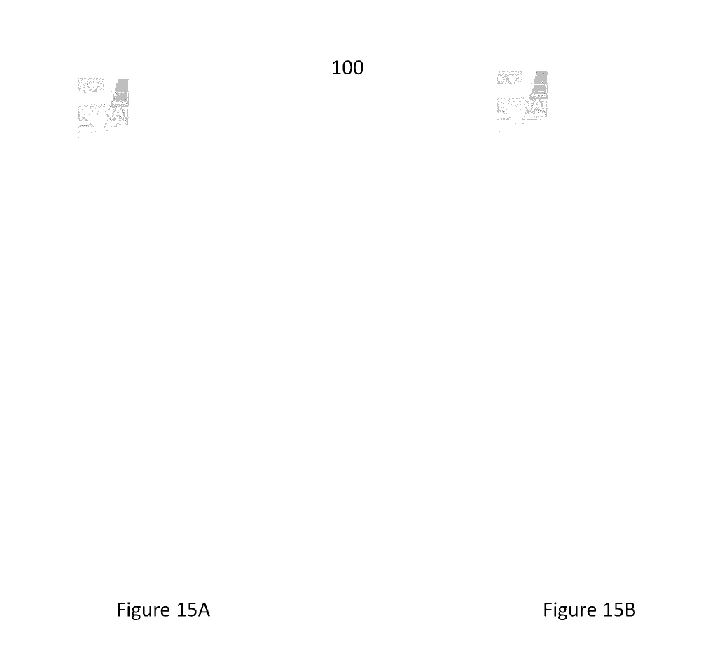

FIG. 15A and FIG. 15B illustrates a donations settings screen that may be accessed through the setting screen shown in FIG. 12. As previously described, the user may set a target amount or a periodic goal. The periodic goal is may be any time period, such as but not limited to, biweekly. The target goal may be any amount.

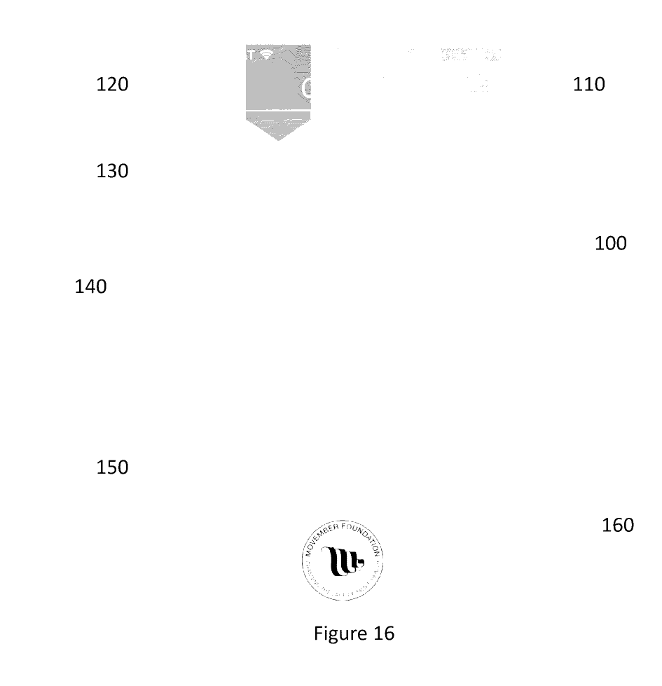

FIG. 16 illustrates another exemplary embodiment of a home screen, similar to FIG. 7. This may be the screen that a registered user first sees after logging into the app 100. The additional feature of a symbol describing or representing the user's selected philanthropic organization 160 may be displayed.

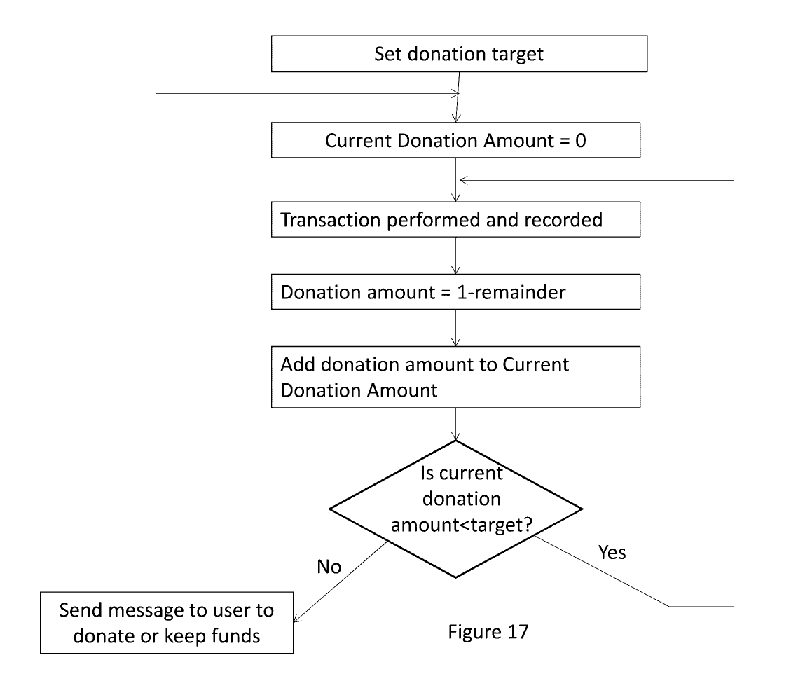

FIG. 17 illustrates an exemplary flowchart of exemplary logic to control the app 100 if a target amount is selected as the donation preference. A donation target amount may be set as previously described. The target may be any amount. Next, the current donation total may be set to zero. As transactions are performed, they may be provisionally rounded up as previously described. The rounded up amounts may be added to the total donation amount and accumulated. The app 100 may check to see if the current donation amount is less than the target. While the current amount is less than the target, this process may be repeated. Once the total amount reaches or exceeds the target, a message may be sent to the user and the user may choose to donate or keep the funds, as previously described.

In exemplary embodiments of the present invention, the process may then be repeated by default except that the previously used donation target is already set. In other exemplary embodiment of the present invention, the user may be required to select a new target or donation preference to continue.

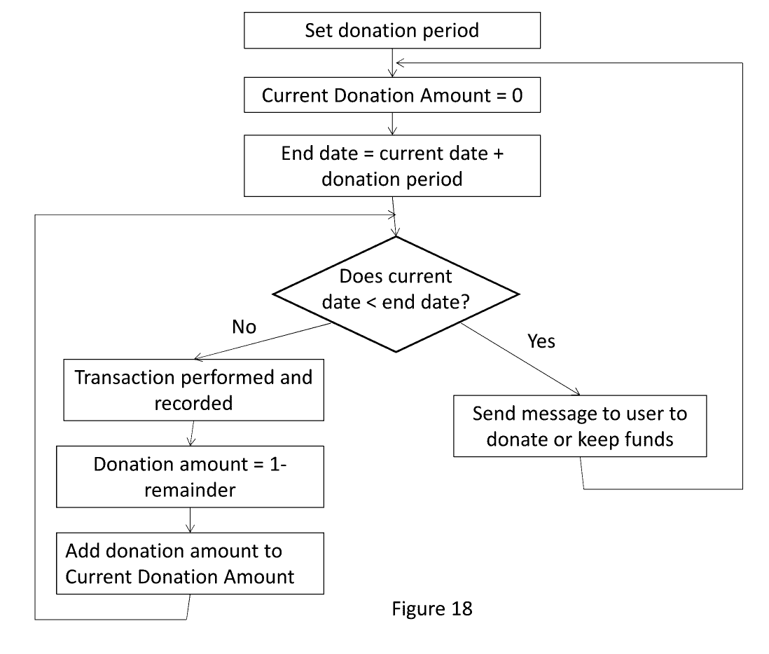

FIG. 18 illustrates an exemplary flowchart of exemplary logic to control the app 100 if a periodic goal is selected as the donation preference. A donation period may be selected as previously described. In exemplary embodiments of the present invention, the time period may bi-weekly, though any time period is contemplated. Next, the current donation total may be set to zero. The end date may be set as the current date plus the donation period, based on a standard calendar. For example, but not to serve as a limitation, if the current date is Oct. 8, 2015 and the time period is set for 2 weeks, the end data may be calculated to be Oct. 22, 2015. The app 100 may check to ensure that the current date before the end date. If the current date is before the end date, then the transactions are performed, provisionally rounded up, and accumulated as previously described. So long as the current date is before the end date, this process may be repeated. Once current date is the same as or after the end date, a message may be sent to the user and the user may choose to donate or keep the funds, as previously described.

In exemplary embodiments of the present invention, the process may then be repeated by default except that the previously used donation period is already set. In other exemplary embodiment of the present invention, the user may be required to select a new donation period or donation preference to continue.

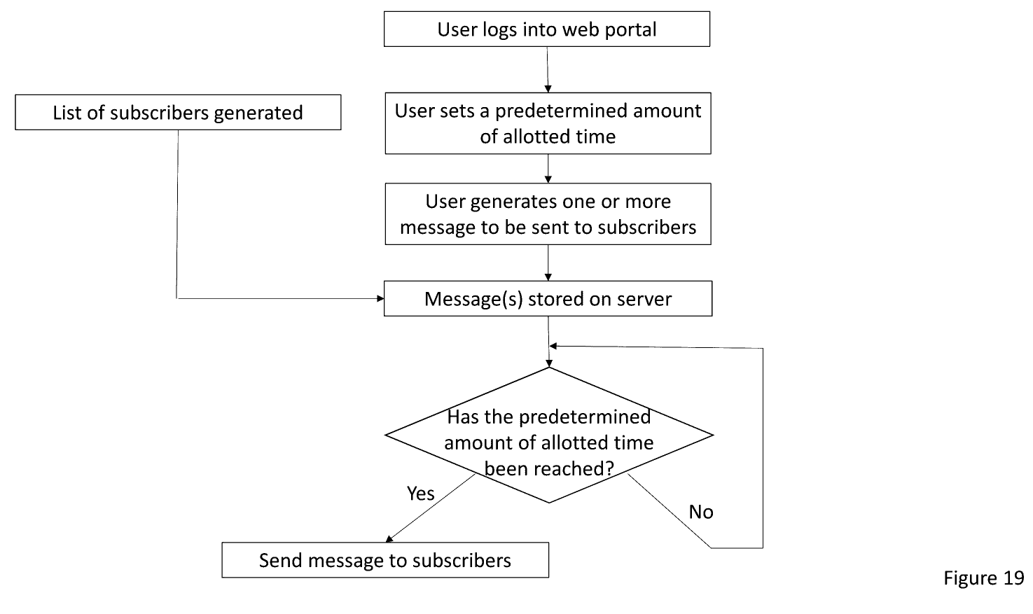

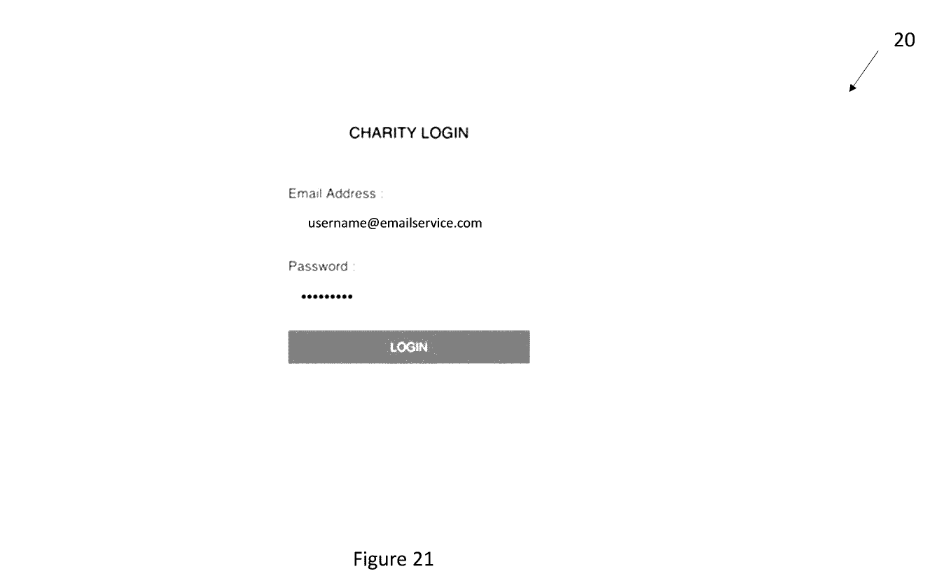

FIG. 19 is an exemplary flow chart in accordance with the present invention. A user may log into a web portal 20 via an electronic device 10. An exemplary web portal 20 is shown in FIG. 21. The user may be a member of an organization such as but not limited to a charitable organization, business, nonprofit, group, club, unincorporated association, or the like. In exemplary embodiments of the present invention, upon the first log in, the user may be required to complete an identification and/or an authorization registration process, which indicates to the system that the user has authority to proceed on behalf of the organization. After logging into the web portal 20, the user may administer various settings associated with the system, including setting a predetermined amount of allotted time when one or more messages 40 should be sent to subscribers or donors to the organization. In exemplary embodiments of the present invention, the predetermined amount of allotted time is a time period, for example without limitation, a message 40 may be sent every week, every 15 days, every month, or every other month. In other exemplary embodiments of the present invention, the predetermined amount of allotted time may be a specified amount of time from when the message 40 is created or may be a recurring date (for example, without limitation, the 15th of each month).

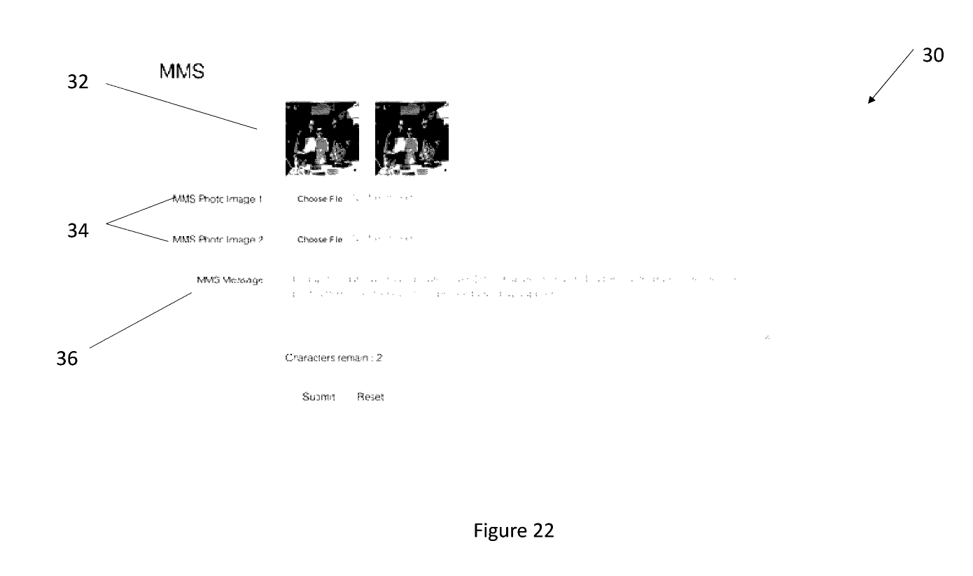

The user may then generate or otherwise supply one or more messages 40 for later distribution. As will be explained in greater detail with respect to FIG. 22, for example without limitation, the user may upload content and draft text to create the message 40 to be sent to their donors or subscribers. The user may generate a single message 40 or multiple messages 40. Additionally, the messages 40 may be generated over multiple sessions. The messages 40 may be stored on a server 12 of the system of the present invention.

Once the predetermined amount of allotted time has been reached, the message 40 is preferably sent to the subscribers or donors, via any number of well-known means, including but not limited to, automated, electronic push means. If multiple messages 40 are stored on the server 12, then in exemplary embodiments of the present invention, the messages 40 may be sent in the order that they were stored on the server 12 or as otherwise specified by the user. For example, without limitation, the user may have selected the messages 40 to be sent out on the 1^{st} of every month. On the 30^{th}, the user may generate two messages 40. The first message 40 may be sent on the 1^{st} of the next month, and the second message 40 may be sent on the 1^{st} of the following month. In the interim, the user may generate additional messages 40 such that there is a backlog of stored messages 40 on the server 12 that are already prepared to be sent to the subscribers when the predetermined amount of time has been reached. Once the message 40 has been sent, the system may wait until the predetermined amount of allotted time has been reached again and then send a second message 40. This process may be repeated any number of times, and in any number of variations of allotted time, order of delivery, message content, message type, and to which recipients, as desired by the user and controlled by the user in a settings control module of the present invention. The control module may reside in the web portal 20.

The user may generate or otherwise obtain a list of intended recipients of the messages 40, such as subscribers or donors to the organization. The list of desired recipients may be entered into the web portal 20 manually by the user, or may be automatically generated or otherwise electronically loaded from a list of contacts, customers, members, donors, subscribers, affiliates, prospects, or the like as stored in compatible software programs and stored in the server 12 of the present invention. In one exemplary embodiment of the present invention the list of intended recipients may be changed by the user at any time.

In exemplary embodiments of the present invention, the user may select one or more recipients for a message 40 to be sent to. For example, but without limitation, if the user's organization has 20 subscribers, the user may draft a first message 40 and designate the message 40 be sent to all 20 subscribers, designate that a second message 40 be sent to subscribers 1-10, and designate that a third message 40 be sent to subscribers 11-20. Practically any number of subscribers may be designated for practically any number of messages 40 (i.e., the messages 40 may be sent to individual subscribers, to all subscribers, or to any number in between). In still other exemplary embodiments of the present invention, the user may create one or more subgroups of subscribers and designate that messages 40 be sent to one or more of said subgroups.

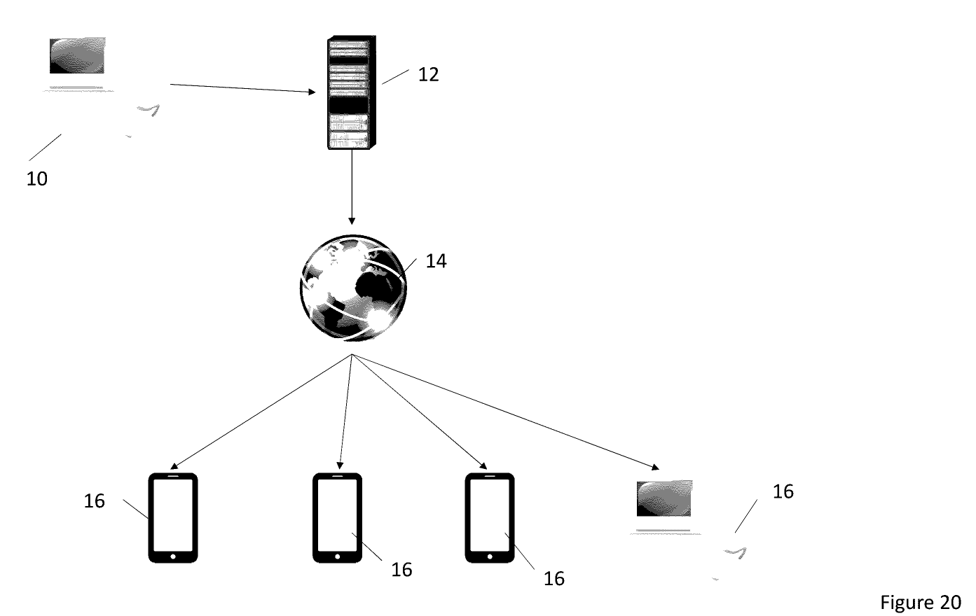

FIG. 20 is an exemplary system in accordance with the present invention. The user's electronic device 10 may be in communication with the server 12. The server 12 may be located locally or remote from the user. Communication may be by way of a wired or wireless connection. Similarly, the server 12 may be in communication with the intended recipients' electronic devices 16 by wired or wireless connection. In exemplary embodiments of the present invention, a user's electronic device 10 is connected to the server, and the server 12 is connected to the recipients' electronic devices 16, by way of the world wide web 14. The recipients may have an application installed on their electronic devices 16 that displays a notification or the content of the message 40 itself upon receipt thereof or upon opening of the application.

FIG. 21 is an exemplary web portal 20. The web portal 20 may facilitate a login process by entering a username or email and a password combination. Again, upon the user's first log in attempt, he or she may be directed to complete a registration process.

FIG. 22 is an exemplary message generator 30. On the message generator 30 the user may upload content 34 such as, but not limited to, photos and other images. The uploaded content may be displayed 32 such that the user can preview the content as it would be displayed to the user and verify that the correct content has been uploaded. The message generator 30 may be an electronic page comprising a text drafting tool 36. The text drafting tool 36 may permit the user to draft text to be sent with the content, if any. In exemplary embodiments of the present invention, the text drafting tool 36 may comprise a character counting tool such that the user may be notified of how many characters he or she has used as compared to a maximum character limit that is dependent on the medium being used for the message 40.

Not all features of the message generator 30 must be utilized for each message 40. For example, without limitation, a first message may comprise two images and lengthy text. A second message may comprise five images and a small amount of text. A third message may contain one image and no text. A fourth image may contain only text. These examples are merely illustrative and are not intended to be limiting. Those having an ordinary level of skill in the art will recognize that any number of images (if any) and any amount of text (if any) may be utilized to comprise each message 40.

While FIG. 22 illustrates the message generator 30 with respect to a multimedia messaging service (MMS), it is contemplated that the message generator 30 may be configured to permit the user to generate any kind of message 40 including, but not limited to, standard messaging service (SMS), social media posts, instant messages, emails, and the like. Additionally, the message generator 30 may be configured to generate messages 40 across one or more formats and computer network platforms.

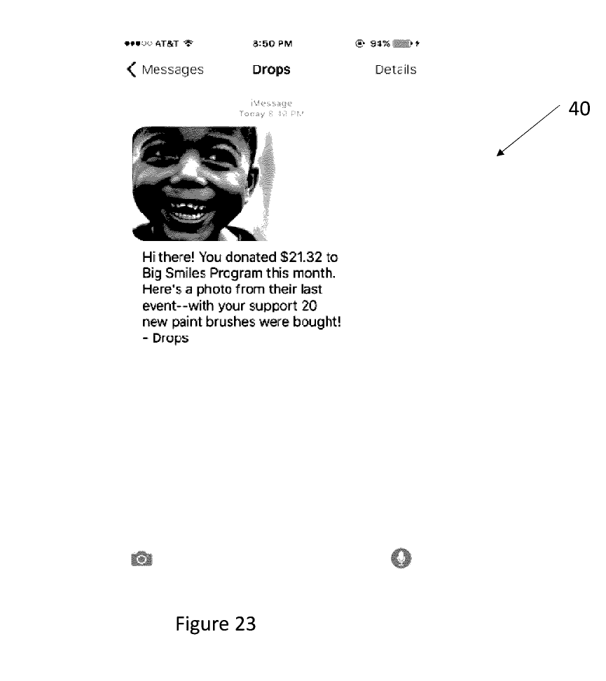

FIG. 23 is an exemplary message 40 as received by a recipient subscriber. The message 40 may comprise an image and/or text. The message 40 may be formatted differently to conform to formatting requirements of the subscriber's electronic device 16. For example, without limitation, the messages 40 may be sent to one subscriber's phone in the form of a MMS or SMS and may be sent to another subscriber's computer in the form of an email. In exemplary embodiments of the present invention, the message 40 may be automatically formatted based on the subscriber's entered contact information. For example, without limitation, if the entered contact information is a phone number the message 40 may be formatted for an MMS message, if the contact is an email address the message 40 may be formatted for email. In other exemplary embodiments of the present invention, the form of the communication may be selected by the user. The selected form of communication may be applied to all subscribers, or the user may select the form of communication for one or more subscribers. As those having skill in the arts will understand, the illustrated content and style of the message 40 is merely exemplary, and accordingly, any style, content, format, and the like of the message 40 is contemplated.

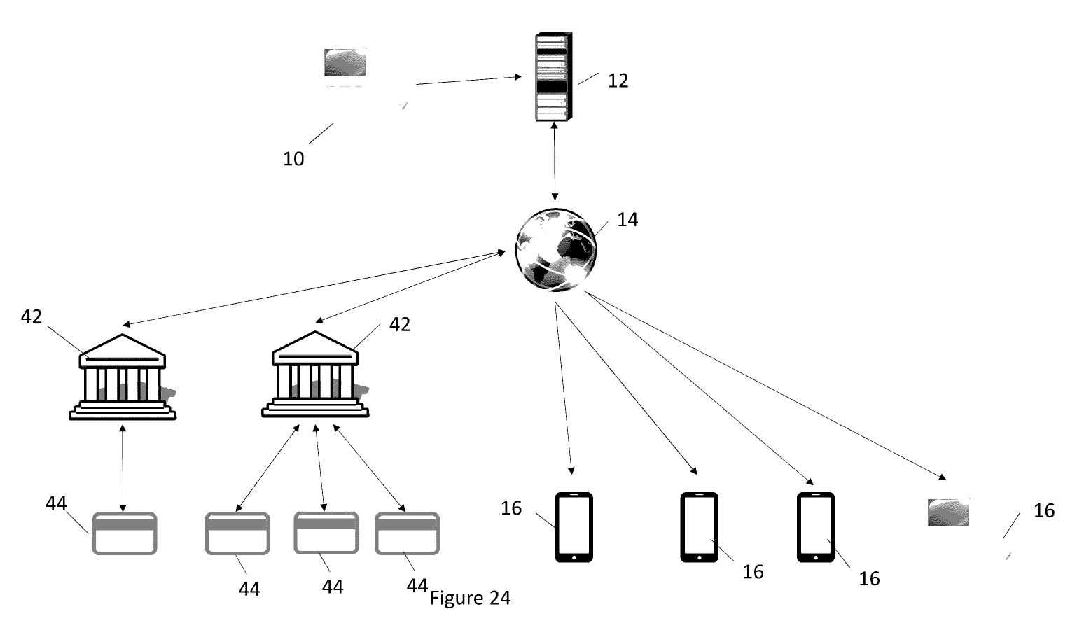

FIG. 24 is an exemplary system in accordance with the present invention. As described in FIG. 1 through FIG. 18 the user may link their payment card and/or bank account 44 with the app 100. The data used to operate the app 100 may be stored on the server 12. In other exemplary embodiments of the present invention, the app 100 may be stored on one or more separate servers which are in communication with the server 12. The user's payment cards and/or bank accounts 44 may be linked to the app 100 through each users' respective bank or other financial institution 42. Information may be communicated between each party by way of a network, such as the world wide web 14. Communication may be by way of a wired or wireless connection. Messages 40 may be sent to the users and/or other subscribers or donors by way of the server 12 as described in FIG. 19 through FIG. 23. In some instances, the user may also be the subscribers or donors, but in other instances they may be separate individuals or organizations.

In exemplary embodiments of the present invention, the app 100 may comprise a transaction monitor for monitoring and recording the user's transactions on the at least one payment card or bank account, a visualization tool for providing a visualization of the progress towards said target amount or periodic goal for donation, and a financial institution interface. The app 100 may be configured for receiving and recording a selection from the user of the philanthropic organization, receiving and recording a selection from the user of a target amount or periodic goal for donation, provisionally rounding up said transactions to the nearest dollar amount, updating user's total donation amount, sending a message to the user stating the total donation amount when said target amount or periodic goal for donation is reached and providing the user with an option to retain or donate said total donation amount, and receiving a selection from the user to retain or donate said total donation amount.

The financial institution interface may be configured for linking the at least one payment card or bank account to the application, transmitting instructions to said financial institution to withdraw or charge said total donation to said at least one payment card or bank account if user so chooses, transmitting instructions to said financial institution to transfer at least a portion of said changed or withdrawn total donation amount to the philanthropic organization selected by the user, and transmitting instructions to the at least one financial institution to transfer a remaining portion of said withdrawn or charged total donation to an administrating organization.

Any embodiment of the present invention may include any of the optional or preferred features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to the described invention. Many of those variations and modifications will provide the same result and fall within the spirit of the claimed invention. It is the intention, therefore, to limit the invention only as indicated by the scope of the claims.

What is claimed is:

1. A system for facilitating micro-donations from a user comprising:
at least one financial institution;
at least one payment card or bank account, each of said at least one payment card or bank account being linked to one of the at least one financial institutions;
a server in communication with said at least one financial institution and being configured to host an application comprising:
a transaction monitor for monitoring and recording transactions on the at least one payment card or bank account;
a visualization tool for providing a visualization of the user's progress towards a target amount or periodic goal for donation; and
a financial institution interface;
wherein the application is configured for:
receiving and recording a selection from the user of a philanthropic organization;
receiving and recording a selection from the user of the target amount or periodic goal for donation;
provisionally rounding up said transactions on the at least one payment card or bank account to the nearest dollar amount;
updating user's total donation amount;
sending a message to the user stating the total donation amount when said target amount or periodic goal for donation is reached and providing the user with an option to retain or donate said total donation amount;
receiving a selection from the user to retain or donate said total donation amount;
wherein the financial institution interface is configured for:
linking the at least one payment card or bank account to the application;
transmitting instructions to said financial institution to withdraw or charge said total donation amount to said at least one payment card or bank account if user so chooses;
transmitting instructions to said financial institution to transfer at least a portion of said charged or withdrawn total donation amount to the philanthropic organization selected by the user; and
transmitting instructions to the at least one financial institution to transfer a remaining portion of said withdrawn or charged total donation to an administrating organization.

2. The system of claim 1 further comprising:
a first electronic device operated by an administrator.

3. The system of claim 2 further comprising:
a second electronic device operated by the user.

4. The system of claim 3 further comprising:
a series of electronic devices, each operated by a subscriber or donor.

5. The system of claim 4 wherein:
said application further comprises:
a web portal; and
a message generator accessible by way of said web portal;
said application is configured to permit the administrator to access said web portal and said message generator by way of said first electronic device.

6. The system of claim 5 wherein:
said application is further configured to:
receive and store a list of subscribers or donors from the administrator;
receive and stores a series of messages generated by said administrator using said message generator;
receive a selection by said administrator as to when said messages will be sent to said subscribers or donors; and
send said messages to said subscribers or donors at the time selected by the administrator.

7. The system of claim 6 wherein:
said message generator is configured to receive administrator uploaded images and administrator generated text; and
said messages comprise said administrator uploaded images and generated text.

8. The system of claim 7 wherein:
said application is configured to send said messages to said subscribers or donors as text messages.

9. The system of claim 7 wherein:
said application is configured to send said messages to said subscribers or donors as emails.

10. The system of claim 1 wherein:
said visualization of the user's roundups and progress towards said target amount or periodic goal for donation is a bucket with water located therein.

11. The system of claim 5 wherein:
said web portal requires the administrator to complete a registration process upon first login.

12. The system of claim 1 wherein:
the message to the user displaying the total donation amount when said target amount or periodic goal for donation is reached is a text message.

13. The system of claim 12 wherein:
the selection received from the user to retain or donate said total donation amount is a text message.

14. A system for facilitating micro-donations from a user comprising:
a server configured to:
communicate with at least one financial institution having at least one linked payment card or bank account; and
host an application;
said application configured to:
communicate with the at least one financial institution;
monitor transactions performed using the at least one linked payment card or bank account;
receive and record the user's selection of a philanthropic organization to contribute donations to;
receive and record the user's selection of a target amount or periodic donation goal;
provide the user's total donation amount;
provisionally round up transactions performed using the at least one linked payment card or bank account to the nearest dollar amount;
update the user's total donation amount;
provide a visualization of the user's total donation amount compared to the target amount or periodic donation goal;
send the user a text message stating the user's total donation amount when said target amount or periodic goal for donation is reached said message providing user with an option to donate the total donation amount or to retain the total donation amount;
receive the user's selection as to donating or retaining the total donation amount;
transmit instructions to the at least one financial institution to withdraw or charge said total donation to said at least one payment card or bank account by way of the at least one financial institution if user so chooses; and
transmit instructions to the at least one financial institution to transfer at least a portion of said withdrawn or charged total donation to the user selected philanthropic organization.

15. The system of claim 14 wherein:
the application is further configured to transmit instructions to the at least one financial institution to transfer a remaining portion of said withdrawn or charged total donation to an administrating organization.

16. The system of claim 14 wherein:
said application comprises:
a web portal; and
a message generator;
said application is configured to permit an administrator to access said web portal and said message generator.

17. The system of claim 16 wherein:
said application is further configured to:
receive a list of subscribers or donors from the administrator;
receive and store a series of messages generated by said message generator;
receive a selection as to when said messages should be sent to said subscribers or donors; and
sending said messages to said subscribers or donors at the selected time.

18. The system of claim 17 wherein:
said message generator is configured to receive images and text; and
said messages contains said images and text.

19. A system for facilitating micro-donations from a user comprising:
a first electronic device operated by an administrator;
a second electronic device operated by a user;
a series of electronic devices, each operated by a subscriber or donor;
at least one financial institution;
at least one payment card or bank account, each of said at least one payment card or bank account being linked to one of the at least one financial institutions; and
a server in communication with said at least one financial institution and being configured to host an application accessible by said administrator via said first electronic device, said user via said second electronic device, and said subscribers or donors by each of said series of electronic devices, said application comprising:
a transaction monitor for monitoring and recording transactions on the at least one payment card or bank account and provisionally rounding up said transactions on the at least one payment card or bank account to the nearest dollar amount;
a visualization tool for providing a visualization of the user's progress towards a target amount or periodic goal for donation;
a financial institution interface; and
a selection tool for receiving and recording a selection from the user of a philanthropic organization and the target amount or periodic goal for donation;
wherein the application is configured to:
updating user's total donation amount;
send a message to the user stating the total donation amount when said target amount or periodic goal for donation is reached and providing the user with an option to retain or donate said total donation amount;
receive a selection from the user to retain or donate said total donation amount;
wherein the financial institution interface is configured to:
link the at least one payment card or bank account to the application;
transmit instructions to said financial institution to withdraw or charge said total donation amount to said at least one payment card or bank account if user so selects;
transmit instructions to said financial institution to transfer at least a portion of said charged or withdrawn total donation amount to the philanthropic organization selected by the user; and
transmit instructions to the at least one financial institution to transfer a remaining portion of said withdrawn or charged total donation to an administrating organization

20. The system of claim 19 wherein:
said application comprises:
a web portal; and
a message generator; and
said application is further configured to:
receive a list of subscribers or donors;
receive and store a series of messages generated by said message generator;
receive and record a selection as to when said messages will be sent to said subscribers or donors; and
sending said messages to said subscribers or donors at the selected time.
